(19) United States
(12) Patent Application Publication
(10) Pub. No.: US 2024/0253544 A1
(43) Pub. Date: Aug. 1, 2024

(54) Vehicle Armrest Cover Device

(71) Applicant: Lillian Steyne, Pensacola, FL (US)

(72) Inventor: Lillian Steyne, Pensacola, FL (US)

(21) Appl. No.: 18/185,750

(22) Filed: Mar. 17, 2023

Related U.S. Application Data
(60) Provisional application No. 63/441,861, filed on Jan. 30, 2023.

(51) Int. Cl. B60N 2/60

(52) U.S. Cl. CPC B60N 2/6036

(57) ABSTRACT

The present invention relates to a vehicle armrest cover device for protecting vehicle armrests. The device is comprised of a body made from a fabric material that can be easily placed over a vehicle armrest via an opening that can be tightened/closed over the armrest via a fastener. The body may be comprised of at least one indicia on the body, or that can be attached to the body via a removable placard. A portion of the body and/or the placard may be made from a foam or padded material for comfort.

### CROSS-REFERENCE TO RELATED APPLICATION

The present application claims priority to, and the benefit of, U.S. Provisional Application No. 63/441,861, which was filed on Jan. 30, 2023, and is incorporated herein by reference in its entirety.

### FIELD OF THE INVENTION

The present invention relates generally to the field of armrest covers. More specifically, the present invention relates to a vehicle armrest cover device with a body made from a fabric material that can be easily placed over a vehicle armrest via an opening. The opening can further be tightened/closed over the armrest via a fastener. The body may be comprised of at least one indicia on the body, or that can be attached to the body via a removable placard. A portion of the body and/or the placard may be made from a foam or padded material for comfort. Accordingly, the present disclosure makes specific reference thereto. Nonetheless, it is to be appreciated that aspects of the present invention are also equally applicable to other like applications, devices, and methods of manufacture.

### BACKGROUND

Nearly all vehicles have armrests. Vehicle armrests, especially leather armrests, can get worn quickly and begin to crack. This can be further exacerbated by temperatures and excessive sunlight exposure that can ruin the armrests and leave them unsightly. In addition, placing an arm on a cracked armrest can be uncomfortable and cause skin irritation to a driver or passenger.

Therefore, there exists a long-felt need in the art for a device that protects a vehicle armrest. There also exists a long-felt need in the art for a vehicle armrest cover device that protects a vehicle armrest from damage. More specifically, there exists a long-felt need in the art for a vehicle armrest cover device that protects a vehicle armrest from cracking due to temperature and sunlight exposure. In addition, there exists a long-felt need in the art for a vehicle armrest cover device that protects a vehicle armrest from cracking due to temperature and sunlight exposure that can be easily applied to any vehicle armrest. Finally, there exists a long-felt need in the art for a vehicle armrest cover device that protects a vehicle armrest from cracking due to temperature and sunlight exposure that can be easily applied to any vehicle armrest and can also be easily customized.

The subject matter disclosed and claimed herein, in one embodiment thereof, comprises a vehicle armrest cover device. The device is primarily comprised of a body, comprised of at least one indicia and at least one opening with at least one fastener. The body is made from a fabric material and can be easily placed over a vehicle armrest via the opening. Then, the opening can be tightened/closed over the armrest via the fastener. The body may be comprised of at least one indicia on the body, or that can be attached to the body via a removable placard. A portion of the body and/or the placard may be made from a foam or padded material for comfort.

In this manner, the vehicle armrest cover device of the present invention accomplishes all the foregoing objectives and provides a vehicle armrest cover device that protects a vehicle armrest from damage due to temperature and sunlight exposure. In addition, the device can be easily applied to any vehicle armrest. Finally, the device can also be easily customized.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a vehicle armrest cover device primarily comprised of a body, comprised of at least one indicia and at least one opening with at least one fastener. The body is preferably comprised of a washable fabric material. The body may be any color known in the art and may be comprised of at least one indicia.

The body may be made from one continuous piece of material or a multi-piece construction from a top panel and at least one side panel that is attached via stitching. The indicia is preferably positioned on the top panel such that it can be easily viewed by a user. However, the indicia may be positioned anywhere on the body.

In one embodiment, the indicia is positioned on at least one removable placard that may be made from a foam or other padded material for comfort. The placard can be attached to the top panel via at least one fastener on the top panel and at least one reciprocating fastener on the bottom surface of the placard.

The body is placed over the armrest of a vehicle during use via at least one opening of the body. The opening can then be tightened around the armrest via at least one fastener. The fastener may be a plurality of fastener types such as, but not limited to, drawstring, zipper, snap button, hook and loop, etc.

Accordingly, the vehicle armrest cover device of the present invention is particularly advantageous as it provides a vehicle armrest cover device that protects a vehicle armrest from damage due to temperature and sunlight exposure. In addition, the device can be easily applied to any vehicle armrest. Finally, the device can also be easily customized. In this manner, the vehicle armrest cover device provides a solution to protecting vehicle armrests from damage.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a vehicle armrest cover device of the present invention while being placed over a vehicle armrest in accordance with the disclosed architecture;

FIG. 2 illustrates a perspective view of one potential embodiment of a vehicle armrest cover device of the present invention while the opening is closed in accordance with the disclosed architecture;

FIG. 3 illustrates a perspective view of one potential embodiment of a vehicle armrest cover device of the present invention with a placard attached to the body in accordance with the disclosed architecture;

FIG. 4 illustrates a perspective view of one potential embodiment of a vehicle armrest cover device of the present invention while the opening is closed in accordance with the disclosed architecture;

FIG. 5 illustrates a perspective view of one potential embodiment of a vehicle armrest cover device of the present invention while secured over a vehicle armrest in accordance with the disclosed architecture; and

FIG. 6 illustrates a flowchart of a method of using one potential embodiment of a vehicle armrest cover device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that protects a vehicle armrest. There also exists a long-felt need in the art for a vehicle armrest cover device that protects a vehicle armrest from damage. More specifically, there exists a long-felt need in the art for a vehicle armrest cover device that protects a vehicle armrest from cracking due to temperature and sunlight exposure. In addition, there exists a long-felt need in the art for a vehicle armrest cover device that protects a vehicle armrest from cracking due to temperature and sunlight exposure that can be easily applied to any vehicle armrest. Finally, there exists a long-felt need in the art for a vehicle armrest cover device that protects a vehicle armrest from cracking due to temperature and sunlight exposure that can be easily applied to any vehicle armrest and can also be easily customized.

The present invention, in one exemplary embodiment, is comprised of a vehicle armrest cover device primarily comprised of a body, comprised of at least one indicia and at least one opening with at least one fastener. The body is preferably comprised of a washable fabric material. The body may be any color known in the art and may be comprised of at least one indicia.

The body may be made from one continuous piece of material or from a multi-piece construction from a top panel and at least one side panel that are attached via stitching. The indicia is preferably positioned on the top panel such that it can be easily viewed by a user. However, the indicia may be positioned anywhere on the body.

Further, in one embodiment the indicia is positioned on at least one removable placard that may be made from a foam or other padded material for comfort. The placard can be attached to the top panel via at least one fastener on the top panel and at least one reciprocating fastener on the bottom surface of the placard.

The body is placed over the armrest of a vehicle during use via at least one opening of the body. The opening can then be tightened around the armrest via at least one fastener. The fastener may be a plurality of fastener types such as, but not limited to, drawstring, zipper, snap button, hook and loop, etc.

Accordingly, the vehicle armrest cover device of the present invention is particularly advantageous as it provides a vehicle armrest cover device that protects a vehicle armrest from damage due to temperature and sunlight exposure. In addition, the device can be easily applied to any vehicle armrest. Finally, the device can also be easily customized. In this manner, the vehicle armrest cover device provides a solution to protecting vehicle armrests from damage.

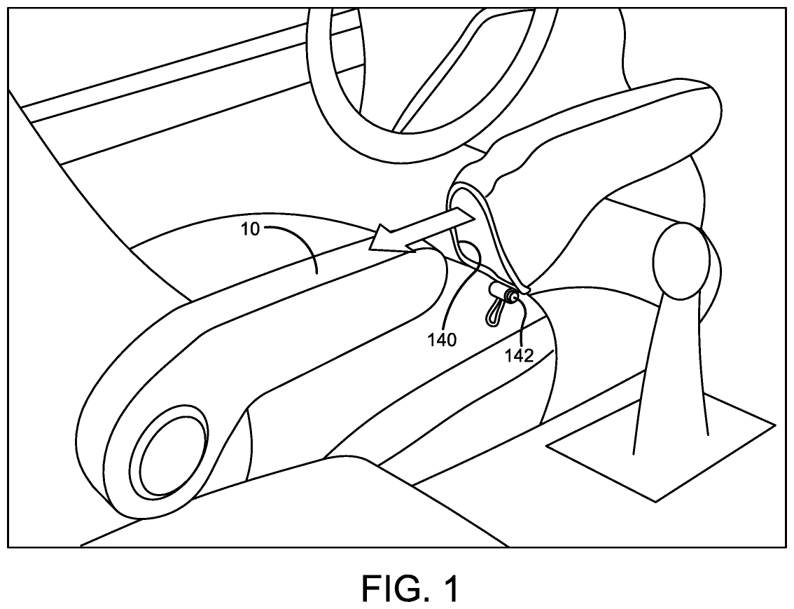

Referring initially to the drawings, FIG. 1 illustrates a perspective view of one potential embodiment of a vehicle armrest cover device 100 of the present invention while being placed over a vehicle armrest 10 in accordance with the disclosed architecture. The device 100 is primarily comprised of a body 110, comprised of at least one indicia 160 and at least one opening 140 with at least one fastener 142. The body 110 is preferably comprised of a fabric material. Said material includes, but is not limited to, vinyl, canvas, cashmere, chenille, chiffon, cotton, damask, jersey, lace, linen, wool, modal, polyester, satin, silk, spandex, suede, tweed, twill, velvet, acrylic, modacrylic, nylon, polypropylene, polyurethane, polyvinyl chloride, polyethylene, vinylidene, benzoate, aramid, rayon, acetate, triacetate, etc. The material of the body 110 is preferably made from a washable material for ease of cleaning.

The body 110 may be any color known in the art. The body 110 may also be comprised of at least one indicia 160. The indicia 160 may include, but is not limited to, patterns, logos, emblems, images, symbols, designs, letters, numbers, words, characters, animals, advertisements, brands, etc.

The body 110 may be made from one continuous piece of material. Alternatively, the body 110 may be made from a top panel 120 and at least one side panel 130 that are attached via stitching 132 or some other fastener of the like. The indicia 160 is preferably positioned on the top panel 120 such that it can be easily viewed by a user. However, the indicia 160 may be positioned anywhere on the body 110.

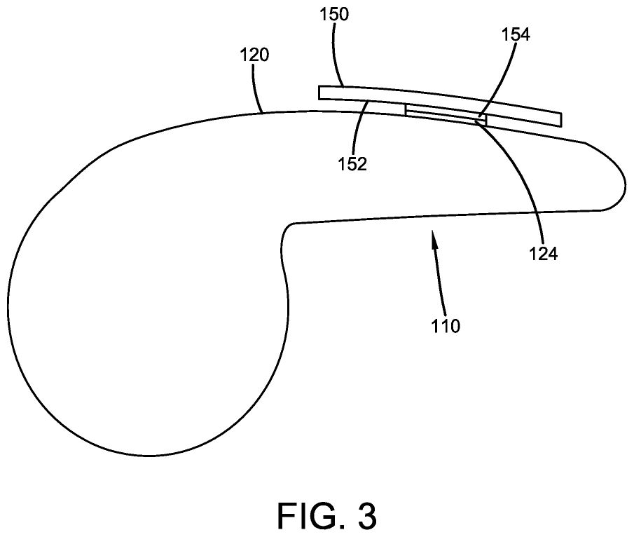

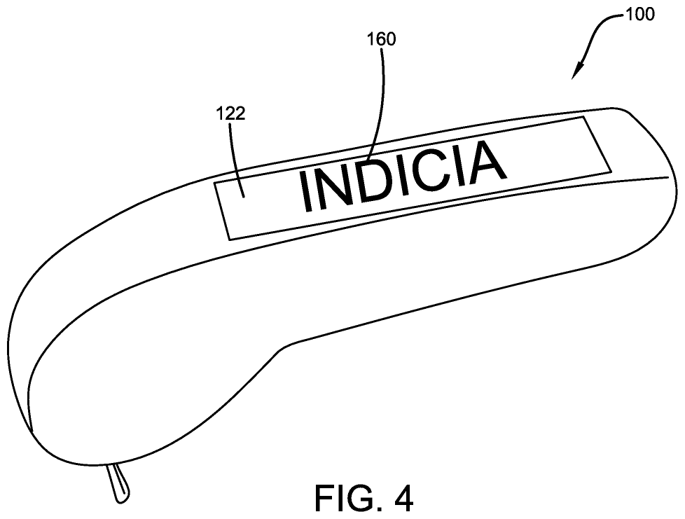

In one embodiment, the indicia 160 is positioned on at least one removable placard 150. The placard 150 may be made from the same material as the body 110. Alternatively, the placard 150 may be made from a foam or other padded material for comfort. The placard 150 can be attached to the top panel 120 via at least one fastener 124 on the top panel 120 and at least one reciprocating fastener 154 on the bottom surface 152 of the placard 150, as seen in FIG. 3. The fasteners 124,154 may be any type of reciprocating fastener known in the art such as, but not limited to, hook and loop, snap button, magnet, etc. In addition, one embodiment of the device 100 with no placard 150 may be comprised of at least one foam 122 (or other padded material) that is stitched within the top panel 120 to achieve the same cushioning effect as the placard 150, as seen in FIG. 4.

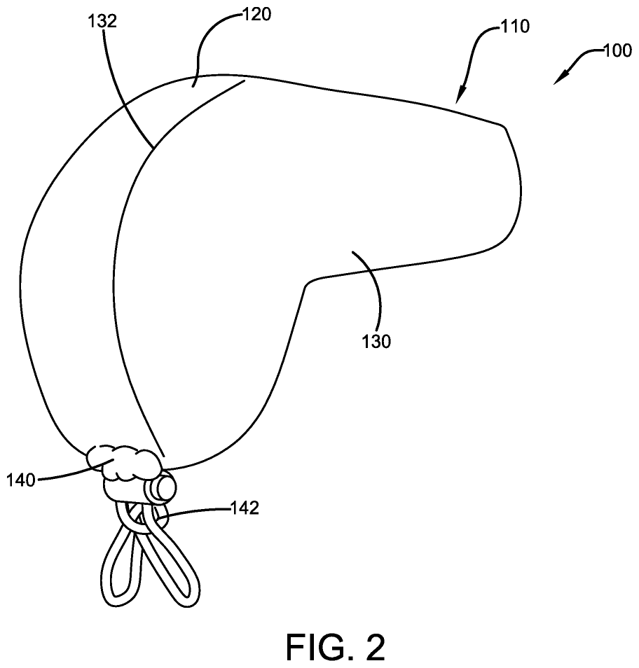

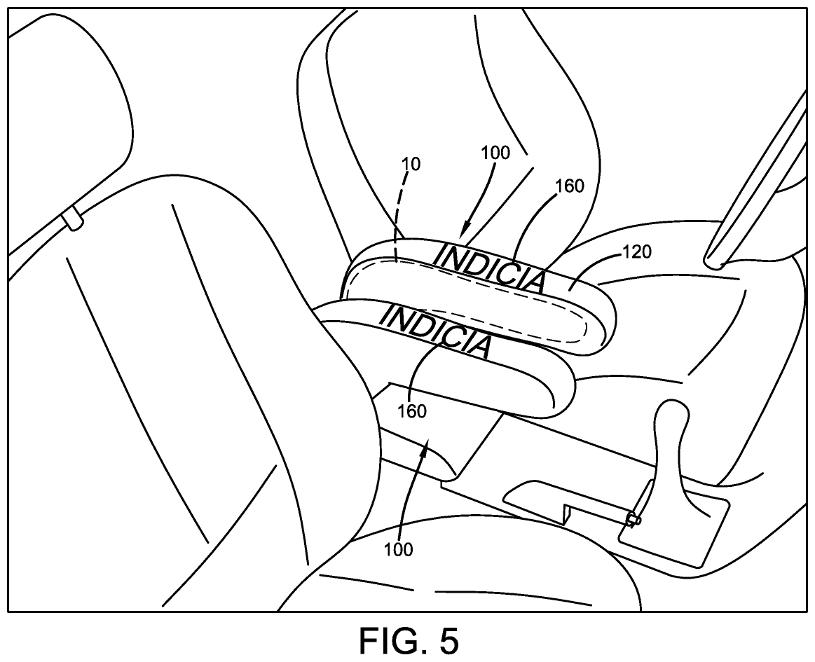

The body 110 is placed over the armrest 10 of a vehicle during use via at least one opening 140 of the body 110, as seen in FIG. 5. The opening 140 can then be tightened around the armrest 10 via at least one fastener 142, as seen in FIG. 2. The fastener 142 may be a plurality of fastener types such as, but not limited to, drawstring, zipper, snap button, hook and loop, etc. The opening 140 may be positioned on any portion of the body 110.

It should be appreciated that the body 110 may be any shape, size, and configuration to fit over any vehicle armrest 10 known in the art.

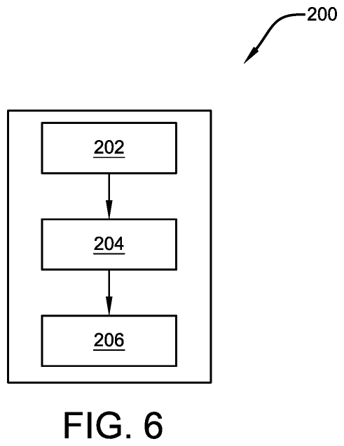

The device 100 may also be comprised of a method of use 200, as seen in FIG. 6. First, a device 100 is provided, comprising a body 110, comprised of at least one indicia 160, a padding 122 and at least one opening 140 with at least one fastener 142 [Step 202]. Then, the opening 140 of the body 110 is placed over a vehicle armrest 10 [Step 204]. Next, the fastener 142 is used to close the opening 140 around the armrest 10 to secure the device 100 to and around the armrest [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “vehicle armrest cover device” and “device” are interchangeable and refer to the vehicle armrest cover device 100 of the present invention.

Notwithstanding the foregoing, the vehicle armrest cover device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the vehicle armrest cover device 100 as shown in the FIGS. are for illustrative purposes only, and that many other sizes and shapes of the vehicle armrest cover device 100 are well within the scope of the present disclosure. Although the dimensions of the vehicle armrest cover device 100 are important design parameters for user convenience, the vehicle armrest cover device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A vehicle armrest cover device comprising:
a body having an opening;
a fastener; and
an indicia.

2. The vehicle armrest cover device of claim 1, wherein the body is comprised of a fabric material.

3. The vehicle armrest cover device of claim 1, wherein the indicia is comprised of a pattern, a logo, an emblem, an image, a symbol, a design, a letter, a word, a character, an animal, an advertisement, or a brand.

4. The vehicle armrest cover device of claim 1, wherein the fastener is positioned around the opening.

5. The vehicle armrest cover device of claim 1, wherein the fastener is comprised of a drawstring fastener.

6. The vehicle armrest cover device of claim 1, wherein the body is comprised of a washable material.

7. The vehicle armrest cover device of claim 1 further comprised of a padding.

8. The vehicle armrest cover device of claim 7, wherein the padding is comprised of a foam material.

9. The vehicle armrest cover device of claim 7, wherein the body is comprised of a top panel.

10. The vehicle armrest cover device of claim 9, wherein the padding is attached within the top panel.

11. The vehicle armrest cover device of claim 1, wherein the body is comprised of a side panel.

12. A vehicle armrest cover device comprising:
a body having an opening;
a first fastener;
a second fastener;
a placard having an indicia; and
a third fastener.

13. The vehicle armrest cover device of claim 12, wherein the first fastener is comprised of a hook fastener, a loop fastener, a magnet fastener, or a snap button fastener.

14. The vehicle armrest cover device of claim 12, wherein the third fastener is comprised of a hook fastener, a loop fastener, a magnet fastener, or a snap button fastener.

15. The vehicle armrest cover device of claim 12, wherein the third fastener is positioned on a bottom surface of the placard.

16. The vehicle armrest cover device of claim 12, wherein the placard is comprised of a padding.

17. The vehicle armrest cover device of claim 16, wherein the padding is comprised of a foam material.

18. The vehicle armrest cover device of claim 12, wherein the indicia is comprised of a pattern, a logo, an emblem, an image, a symbol, a design, a letter, a word, a character, an animal, an advertisement, or a brand.

19. The vehicle armrest cover device of claim 12, wherein the second fastener is comprised of a drawstring, a zipper, a snap button, or a hook and loop fastener.

20. A method of using a vehicle armrest cover device, the method comprising the steps of:
providing a vehicle armrest cover device, the device comprised of a body comprised of an indicia, a padding, and an opening with a fastener;
placing the opening over a vehicle armrest; and
tightening the fastener to close the opening around the vehicle armrest.
